(19) United States
(12) Patent Application Publication
(10) Pub. No.: US 2024/0180775 A1
(43) Pub. Date: Jun. 6, 2024

(54) Masturbation System and Method of Preparation for Use

(71) Applicant: Stanislav Kulyk, Lublin (PL)

(72) Inventor: Stanislav Kulyk, Lublin (PL)

(21) Appl. No.: 18/061,380

(22) Filed: Dec. 2, 2022

(51) Int. Cl. A61H 19/00

(52) U.S. Cl. CPC A61H 19/00; A61H 2201/1207; A61H 2201/1664; A61H 2201/1685; A61H 2201/501; A61H 2201/5038

(57) ABSTRACT

Provided is a masturbation system and method of use, the system comprising a power source, an arm mount, a monorail platform fixedly connected to the arm mount, a train platform slidably coupled and engaged with the monorail platform, and a toy receiving piece removably attached to the train platform, wherein the toy receiving piece is configured to receive and secure a removably attachable adult toy.

### BACKGROUND OF THE INVENTION

Masturbators, devices that mechanically stimulate a user's sexual organs for the purpose of providing the user with sexual pleasure, are common products in the contemporary adult toys market. A common type of masturbator is an artificial male penis used for vaginal or anal insertion typically referred to as a dildo. There also exists male masturbators that simulate female vaginas used for penile penetration typically referred to as onaholes. Such masturbators can be handheld and non-electric, generally comprising a shaped piece of silicone, TPE, or other soft rubber-like and skin-friendly material, and require the user's physical effort to reach orgasm.

Masturabtors can also be electric, comprising the aforementioned components as well as mechanical and electrical components. Such electric masturbators allow the user to reach orgasm with less physical effort or even no effort if the user utilizes hands-free devices. Presently, dildo masturbators with internal vibrating motors are very common on the market. However, to an extent, they still require active physical movement by the user to reach orgasm. Additionally present are mechanical dildo masturbators configured to fully automate the penetration process. U.S. Pat. No. D955,597 S is an example of such a mechanical masturbator. Such masturbators, however, utilize a slider-crank mechanism that cannot be readily adjusted to alter the penetration/sliding depth of an attachment. Considering that the dimensions of vaginas, penises, and anuses may vary considerably, the aforementioned restriction in depth can result in medical injuries for the user.

There also exists electronic masturbators typically used by men such as silicone or TPE vaginas embedded into a plastic housing, the artificial vaginas being configured to provide vibrations, vacuum suction, or massaging sensations to the user's genitalia. In some devices, massage motors grip the penis via the silicone part(s), sometimes with a plurality of internal balls or bumps. As the electronic parts of such devises are typically integrated into the silicone or TPE portions of the device, it is of great difficulty to replace the silicone or TPE portions while preserving the function of the electronics. Essentially, if a user is dissatisfied with the product, they are required to purchase additional silicone parts or an entirely new device, vastly overpaying for the electronic portion of the masturbator as a result.

Based on the aforementioned information, there is a need in the market for an electrically powered mechanical masturbator that can be readily adjusted for each user's individual purposes without the need for a multitude of products or devices to be purchased.

### SUMMARY OF THE INVENTION

Accordingly, the inventor has conceived and reduced to practice, a masturbation system and method of use that provides a better user experience by combining a rail-based movement system, a readily repositionable arm, and a toy receiving piece configured to readily receive a plurality of adult toys and allow the user to customize the toy receiving piece's mechanical movement during use.

According to a preferred embodiment, a masturbation system is disclosed comprising a power source, an arm mount, a monorail platform fixedly connected to the arm mount, a train platform slidably coupled and engaged with the monorail platform, and a toy receiving piece removably attached to the train platform, wherein the toy receiving piece is configured to receive and secure a removably attachable adult toy.

According to an aspect of an embodiment, the system further comprises a mounting clamp fixedly connected to the arm mount and configured to fixedly removably attached the system to a stationary object during use.

According to an aspect of an embodiment, the system further comprises a stationary base fixedly connected to the second end of the arm mount and configured to stabilize the system during use.

According to an aspect of an embodiment, a rack and pinion drive is utilized to engage the train platform with the monorail platform.

According to an aspect of an embodiment, a wheel and track engagement is utilized to engage the train platform with the monorail platform.

According to an aspect of an embodiment, the toy receiving piece is a universal connector such that the toy receiving piece is configured to secure a wide variety of dildo and onahole static masturbators.

### BRIEF DESCRIPTION OF DRAWINGS

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a perspective view of an exemplary masturbator system utilizing an artificial vagina according to a preferred embodiment.

FIG. 2 is a perspective view of the exemplary system of FIG. 1 utilizing an artificial penis rather than an artificial vagina.

FIG. 3 shows the internal workings of the toy receiving piece and the system of engagement between the monorail platform and the train platform of the exemplary system of FIG. 1.

FIG. 4 is a flow chart showing the method to set up the masturbator system for use.

### DETAILED DESCRIPTION OF THE INVENTION

It is to be understood that the term “onahole” refers to the neologism borrowed from the Japanese language and means artificial vagina, usually made from silicone or TPE material.

It is to be understood that the term “dildo” refers to an artificial male penis made from silicone, TPE, glass, rubber, or other semi-soft or hard materials, friendly for human skin.

It is to be understood that the terms “onahole”, “male masturbator”, and “artificial vagina” are used interchangeably within this application.

It is to be understood that the terms “dildo”, “female masturbator”, and “artificial penis” are used interchangeably within this application.

It is to be understood that the term “calibration” used within this application refers to the process of finding a proper insertion depth for the adult toy utilized by the system.

It is to be understood that the term “mobile device” refers to a smartphone, tablet, or laptop.

The mobile device may store in its memory one or more computer programs or software applications (hereinafter referred to as “application” or “applications”). In some possible implementations, an application is configured to run on the mobile device and may be downloaded and installed on the mobile device

It is to be understood that the term “wireless module” used within this application refers to a Bluetooth®, Wi-fi, or cellular internet modem hardware component sharing remote access to the system's control software with a user's mobile device.

It is to be understood that the term “TPE” refers to the thermoplastic elastomer.

It is to be understood that the term “GUI” refers to a graphical user interface.

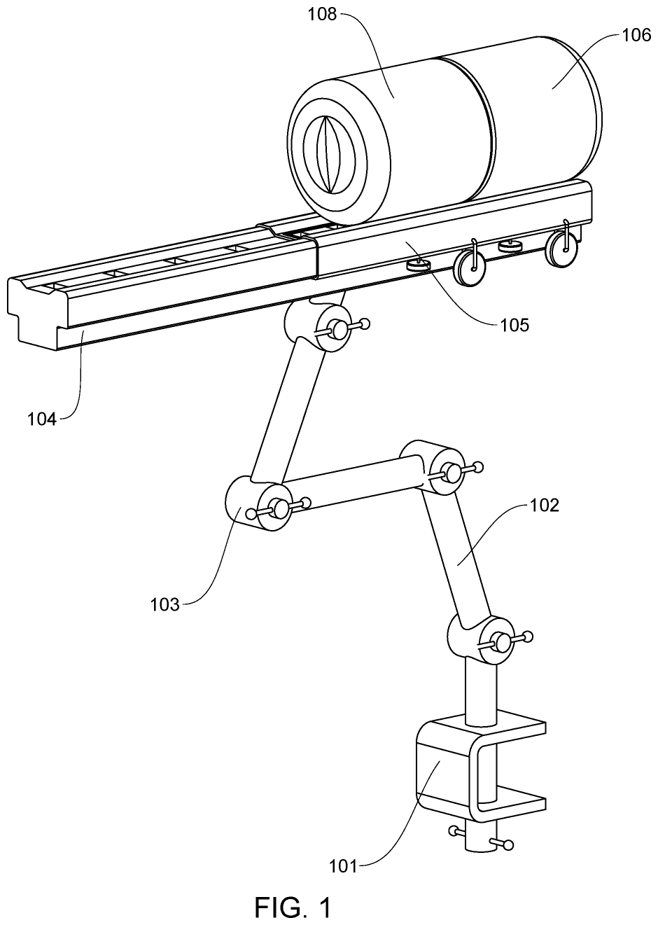

FIG. 1 shows an exemplary masturbator system according to the preferred embodiment. This embodiment comprises an arm mount, the arm mount comprising one or more posts 102 mechanically coupled with one or more coupling pieces 103 that in use rotationally fixedly engage the one or more posts, a monorail platform 104 fixedly connected and engaged to the first end of the arm mount, a train platform 105 slidably coupled and engaged with the monorail platform 104, a toy receiving piece 106 removably attached to the train platform 105. The toy receiving piece 106 is configured to receive and secure a removably attachable toy such as the shown artificial vagina 108, and a mounting clamp removably attached to a post from the one or more posts 102 and configured to removably attach the system to a stationary object during use. The monorail platform has a first end and a second end as well as a slidable axis defined by the first end and the second end. The train platform, when slidable coupled and engaged with the monorail platform, can move back and forth along the slidable axis during use.

In the preferred embodiment, the toy receiving piece 106 provides a universal connection such that the piece is configured to removably secure a wide variety of dildo and onahole static masturbators.

In some embodiments, the system further comprises a stationary base removably attached to the second end of the arm mount and configured to stabilize the system during use.

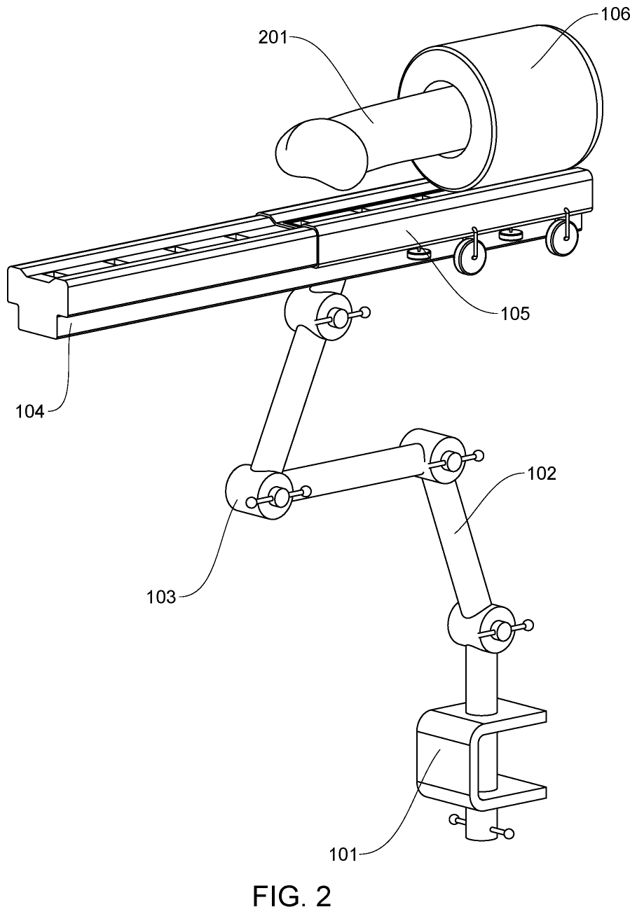

FIG. 2 shows the exemplary system of FIG. 1 utilizing an artificial penis rather than an artificial vagina, demonstrating the universal connection functionality of the toy receiving piece 106.

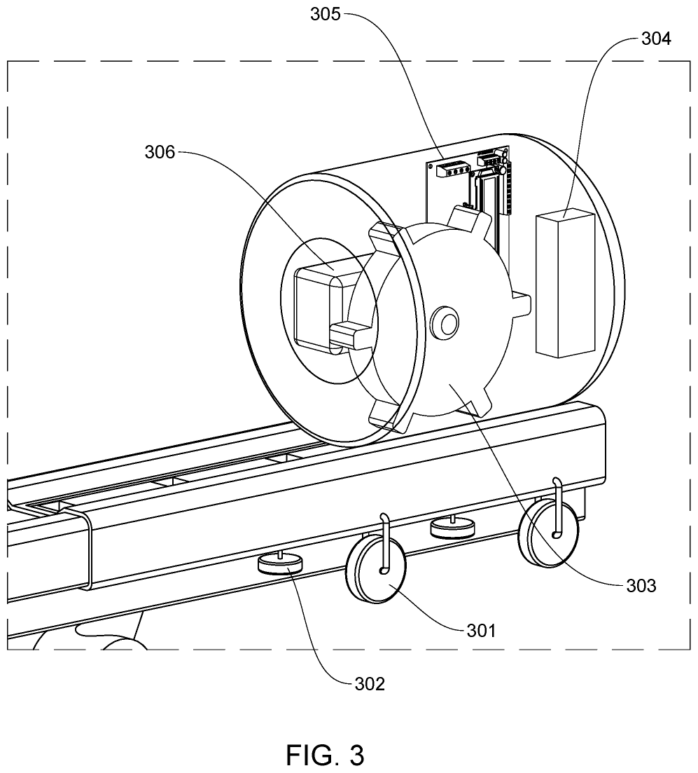

FIG. 3 shows the internal workings of the toy receiving piece and the system of engagement between the monorail platform and the train platform of the exemplary system of FIG. 1. The toy receiving piece 106 comprises a housing containing: a motor system 306 configured to slidably move the train platform 105 back and forth along the slidable axis of the monorail platform 104, a computer 305 having a processor and a memory, and a power source 304. In the exemplary embodiment shown, the power source 304 is a portable device that produces a voltage or current power such as a battery that is secured inside of the housing of the toy receiving piece 106. The motor system 306 is coupled to the power source 304. The computer 305 is coupled to the power source 304. The computer 305 is communicatively coupled to the motor system 306. The processor of the computer 305 is configured to store and access user preference data from the memory.

In some embodiments, the toy receiving piece 106 is removably attached to the top surface of the train platform 105 such that the user can detach the toy receiving piece 106 in order to easily remove or change the adult toy secured by the toy receiving piece 106.

In some embodiments, the train platform 105 is slidably coupled and engaged with the monorail platform 104 using one or more vertical safety wheels 301 and one or more horizontal safety wheels 302.

In some embodiments, the system utilizes a rack and pinion drive between the monorail platform 104 and the train platform 105 wherein the monorail platform further comprises a linear gear along the slidable axis of the monorail platform 104 and the motor system 306 further comprises a circular gear 303 configured to engage the linear gear.

In some embodiments, the system utilizes a wheel and track engagement between the monorail platform 104 and the train platform 105 wherein the monorail platform 104 further comprises a track along the slidable axis of the monorail platform 104 and the motor system 306 further comprises an embossed rubber wheel configured to frictionally engage the track.

In some embodiments, the power source is an external direct current power source.

In some embodiments, the power source is an external alternating current power source.

In some embodiments, the computer 305 is a microcontroller board with a wireless module.

In some embodiments, the system further comprises a mobile device application having a GUI configured to allow the user to interact and communicate with the computer 305 and/or system.

In some embodiments, the system may be controlled by an integrated circuit (IC) built into the computer 305 which controls the operation of the motor system 306. The IC may be pre-programmed or may, through a universal serial bus (USB) or other interface, be user programmable using a computer application. In either case, the IC may control the operation of the device by adjusting motor speed and direction to implement the patterns of stimulation programmed into the IC.

In some embodiments, the system may further comprise sensors that may be used to set limits of motion of the train platform 105 along the monorail platform 106, to ensure that the mechanism is at one end of its range of motion prior to operation, or to detect and protect against other device parameters such as motor over-heating. Sensors may be of any type suitable for the purpose, including but not limited to electrical contacts, magnetic sensors, magnetic reed switches, mechanical switches, rotational sensors, optical sensors, and temperature sensors.

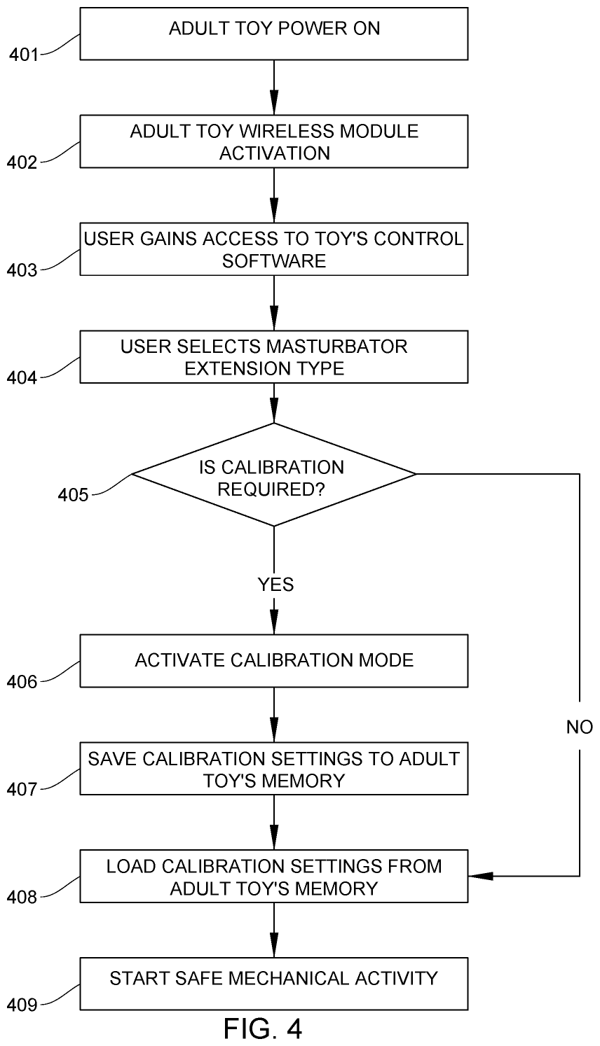

FIG. 4 is a flow chart showing the method to set up the masturbator system for use according to an exemplary embodiment of the present invention. First, the user turns on the system 401 by pressing a button on the system's housing. The user then communicatively couples the computer of the system with the mobile device of the user 402, 403 using an application running on the mobile device. This coupling process may be done manually or automatically. Next, the user selects and removably attaches the desired adult toy to the toy receiving piece 106. The selected adult toy is then selected in the application 404. In response to determining that calibration is required for the selected adult toy based on the lack of presence of previously stored user-desired calibration settings corresponding to the selected adult toy in the memory of the computer of the system, the system then begins the calibration process to determine the desired adult toy oscillation distance 406. During the calibration process, the user should be prepared for mechanical interaction of the attached adult toy with their genitals. First, the motor system 306 starts moving the train platform 105 with a low velocity from the end of the slidable axis furthest away from the user's genitals along the slidable axis towards the user's genitals. Once the train platform holding the attached adult toy reaches the user's ideal distance, the user can stop the movement of the train platform using the application. This user-desired adult toy oscillation distance is then stored in the memory of the computer of the system for future reference. If the previously stored user-desired calibration settings corresponding to the selected adult toy in the memory of the computer of the system are detected, these desired calibration settings are automatically set for the system prior to use.

In some embodiments, the calibration process is completed entirely on the mobile application.

In some embodiments, the user can manually update calibration settings at any time using the application.

In some embodiments, the user can calibrate the system only using the computer of the system and one or more buttons communicatively coupled to the computer.

I claim:

1. A masturbation system comprising:
a power source;
an arm mount having a first end and a second end, the arm mount comprising one or more posts mechanically coupled with one or more coupling pieces that in use rotationally fixedly engage the one or more posts;
a monorail platform fixedly connected to the first end of the arm mount, the monorail platform having a first end and a second end and a slidable axis defined by the first end and the second end;
a train platform slidably coupled and engaged with the monorail platform, the train platform having a top surface;
a toy receiving piece removably attached to the top surface of the train platform, the receiving piece comprising:
a motor system configured to slidably move the train platform along the slidable axis of the monorail platform; and,
a computer having a processor and a memory;
wherein the motor system is coupled to the power source;
wherein the computer is coupled to the power source;
wherein the computer is communicatively coupled to the motor system;
wherein the processor is configured to store and access user preference data from the memory;
wherein the toy receiving piece is configured to receive a removably attachable toy.

2. The masturbation system of claim 1, further comprising a mounting clamp removably attached to the second end of the arm mount and configured to removably attach the system to a stationary object during use.

3. The masturbation system of claim 1, further comprising a stationary base removably attached to the second end of the arm mount and configured to stabilize the system during use.

4. The masturbation system of claim 1, wherein the power source is a portable device that produces a voltage or current power attached to an exterior surface of the system.

5. The masturbation system of claim 1, wherein the power source is a portable device that produces a voltage or current power secured inside of the toy receiving piece.

6. The masturbation system of claim 1, wherein the power source is an external power source electrically coupled to the system.

7. The masturbation system of claim 1, further comprising a rack and pinion drive between the monorail platform and the train platform wherein the monorail platform further comprises a linear gear along the slidable axis of the monorail platform and the motor system further comprises a circular gear configured to engage the linear gear.

8. The masturbation system of claim 1, further comprising a wheel and track engagement between the monorail platform and the train platform wherein the monorail platform further comprises a track along the slidable axis of the monorail platform and the motor system further comprises an embossed rubber wheel configured to frictionally engage the track.

9. A method of preparing a masturbation system for use comprising the steps of:
turning on the system;
communicatively coupling the computer of the system to a mobile device of a user;
removably attaching the desired adult toy with the toy receiving piece;
selecting the attached adult toy in the mobile application on the mobile device;
in response to determining that calibration is required for the selected adult toy based on the lack of presence of previously stored user-desired calibration settings corresponding to the selected adult toy in the memory of the computer of the system:
calibrating the system to the user-desired adult toy oscillation distance;
storing the user-desired adult toy oscillation distance in the memory of the computer of the system; and,
in response to determining that calibration is not required for the selected adult toy based on the presence of previously stored user-desired calibration settings corresponding to the selected adult toy in the memory of the computer of the system:
loading the corresponding calibration settings from the memory of the computer for use by the system.
